(19) United States
(12) Patent Application Publication
(10) Pub. No.: US 2025/0196438 A1
(43) Pub. Date: Jun. 19, 2025

(54) HYBRID MANUFACTURING DEVICES FOR ADDITIVE AND SUBTRACTIVE MANUFACTURING PROCESSES

(71) Applicant: Blue Origin, LLC, Kent, WA (US)

(72) Inventors: W. Douglas Hartley, Renton, WA (US); Kris Heitmeyer, Sumner, WA (US); Max Jensen, Seattle, WA (US); Kam To Law, Seattle, WA (US)

(21) Appl. No.: 18/979,166

(22) Filed: Dec. 12, 2024

Related U.S. Application Data
(60) Provisional application No. 63/611,053, filed on Dec. 15, 2023.

(51) Int. Cl. B29C 64/209; B29C 64/30; B33Y 10/00; B33Y 30/00; B33Y 40/20

(52) U.S. Cl. CPC B29C 64/209; B29C 64/30; B33Y 10/00; B33Y 30/00; B33Y 40/20

(57) ABSTRACT

Additive manufacturing devices with subtractive tools are provided. In one aspect, an additive manufacturing device includes a shoulder configured to rotate about a central axis, the shoulder including a central channel extending from a first end of the shoulder to a second end of the shoulder, the central channel configured to allow a filler material to pass through the shoulder from the first end towards the second end. The additive manufacturing device also includes a subtractive tool assembly including a subtractive tool and an insert sleeve. At least a portion of one or more cutting surfaces or edges of the subtractive tool extend outside the central channel of the shoulder when the subtractive tool is removably received in the insert sleeve and the insert sleeve is received in the central channel of the shoulder.

### CROSS-REFERENCE TO RELATED APPLICATIONS

This application claims the benefit of U.S. Provisional Application No. 63/611,053, filed Dec. 15, 2023, which is hereby incorporated by reference in its entirety.

### BACKGROUND

### Field

The technology relates to hybrid manufacturing systems and devices that can be used to perform both additive and subtractive manufacturing processes.

### Description of the Related Art

Typically, separate subtractive tooling is needed to machine material deposited through additive manufacturing processes. It is therefore desirable to have tooling that can be used for both additive and subtractive purposes.

### SUMMARY

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing additive manufacturing and subtractive manufacturing devices and systems.

In one aspect, an additive manufacturing device includes a shoulder and a subtractive tool assembly. The shoulder is configured to rotate about a central axis. The shoulder includes a central channel extending from a first end of the shoulder to a second end of the shoulder. The central channel is configured to allow a filler material to pass through the shoulder from the first end towards the second end. The subtractive tool assembly includes a subtractive tool and an insert sleeve. The subtractive tool includes a first end and one or more cutting surfaces or edges at a second end. The insert sleeve includes an insert cavity configured to removably receive the subtractive tool. The insert sleeve is configured to be received in the central channel of the shoulder to couple the subtractive tool to the shoulder. At least a portion of the one or more cutting surfaces or edges of the subtractive tool extends outside the central channel of the shoulder when the first end of the subtractive tool is removably received in the insert cavity of the insert sleeve and the insert sleeve is received in the central channel of the shoulder.

In some embodiments, the subtractive tool includes a drill bit or a milling insert. In some embodiments, the insert sleeve includes a first portion configured to be received in the central channel and a second portion configured to abut a tool face at the second end of the shoulder. In some embodiments, the insert sleeve includes a first magnet positioned in a cavity of the first portion and a second magnet positioned in a cavity of the second portion. The first magnet and the second magnet are configured to couple the insert sleeve to the shoulder. In some embodiments, the device includes one or more fasteners configured to couple the subtractive tool to the insert sleeve at a first end of the insert cavity and a second, opposite end of the insert cavity. In some embodiments, the insert sleeve is configured to be coupled to the shoulder with a fastener positioned within a fastener channel that extends from an outer surface of a sidewall of the shoulder to a wall defining the central channel of the shoulder. In some embodiments, the insert sleeve is configured to be coupled to the shoulder with a glue. In some embodiments, the central channel includes a square cross-sectional shape, an outer shape of the insert sleeve includes a square cross-sectional shape, and the insert cavity includes a circular cross-sectional shape.

In another aspect, an additive manufacturing device includes a shoulder and a subtractive tool. The shoulder is configured to rotate about a central axis. The shoulder includes a central channel extending from a first end of the shoulder to a second end of the shoulder. The central channel is configured to allow a filler material to pass through the shoulder from the first end towards the second end. The subtractive tool includes a first end and one or more cutting surfaces or edges at a second end. The subtractive tool is configured to be removably received in the central channel of the shoulder. At least a portion of the one or more cutting surfaces or edges of the subtractive tool extends outside the central channel of the shoulder when the first end of the subtractive tool is removably received in the central channel of the shoulder.

In some embodiments, the subtractive tool includes a drill bit or a milling insert. In some embodiments, the subtractive tool is configured to be coupled in the central channel with one or more screws. In some embodiments, the subtractive tool is configured to be directly coupled to the central channel of the shoulder. In some embodiments, the subtractive tool is configured to be indirectly coupled to the central channel of the shoulder. In some embodiments, the central channel includes a circular cross-sectional shape and the first end of the subtractive tool comprises a circular cross-sectional shape. In some embodiments, the device includes a second subtractive tool comprising a first end and one or more cutting surfaces or edges at a second end. The second subtractive tool is configured to be removably received in the central channel of the shoulder. At least a portion of the one or more cutting surfaces or edges of the second subtractive tool extends outside the central channel of the shoulder when the first end of the second subtractive tool is removably received in the central channel of the shoulder.

In another aspect, a method of manufacturing a part includes advancing an additive manufacturing device over a substrate. The additive manufacturing device includes a shoulder having a central channel configured to deposit a filler material. The shoulder is configured to rotate as the additive manufacturing device is advanced. The method also includes depositing the filler material to build a part. The method also includes coupling a subtractive tool at least partially in the central channel of the shoulder. The method also includes machining at least a portion of the part using the subtractive tool.

In some embodiments, the method includes coupling the subtractive tool at least partially received in the central channel of the shoulder using one or more fasteners. In some embodiments, the method includes coupling the subtractive tool at least partially received in the central channel of the shoulder using one or more magnets. In some embodiments, the method includes removably receiving the subtractive tool at least partially in an insert cavity of an insert sleeve and inserting the insert sleeve in the central channel of the shoulder. In some embodiments, the method includes coupling the insert sleeve to the shoulder using one or more fasteners positioned within a fastener channel that extends from an outer surface of a sidewall of the shoulder to a wall defining the central channel of the shoulder. In some embodiments, the machining includes drilling one or more holes in the part. In some embodiments, machining includes machining an outer surface of the part to reduce a dimension of the part. In some embodiments, the method includes removing the subtractive tool from the central channel of the shoulder, advancing the additive manufacturing device over the portion of the part machined using the subtractive tool as the additive manufacturing device deposits filler material, coupling a second subtractive tool different than the subtractive tool at least partially in the central channel of the shoulder, and machining at least a portion of the part using the second subtractive tool.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. Understanding that these drawings depict only several embodiments in accordance with the disclosure and are not to be considered limiting of its scope, the disclosure will be described with additional specificity and detail through use of the accompanying drawings. In the drawings, similar symbols typically identify similar components, unless context dictates otherwise. The illustrative embodiments of the present disclosure are not meant to be limiting. Other embodiments may be utilized, and other changes may be made, without departing from the spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of the present disclosure.

FIG. 1 is a schematic illustration of an example friction stir additive manufacturing process and device according to an embodiment of the present disclosure.

FIG. 2A is a bottom perspective view of an example hybrid device including example subtractive features according to an embodiment of the present disclosure.

FIG. 2B is top perspective view of the hybrid device of FIG. 2A.

FIG. 2C is a bottom view of the hybrid device of FIG. 2A.

FIG. 2D is a side view of the hybrid device of FIG. 2A.

FIG. 2E is a perspective view of a deposition end of the hybrid device of FIG. 2A.

FIGS. 3A-3B are schematic illustrations of the hybrid device of FIG. 2A being used to deposit material through an example additive manufacturing process according to an embodiment of the present disclosure.

FIG. 4 is a schematic illustration of the hybrid device of FIG. 2A being used to remove material through an example subtractive manufacturing process according to an embodiment of the present disclosure.

FIG. 5A is a top perspective view of an example hybrid device including example subtractive features according to another embodiment of the present disclosure.

FIG. 5B is a bottom perspective view of the hybrid device of FIG. 5A.

FIG. 5C is a bottom view of the hybrid device of FIG. 5A.

FIG. 5D is a side view of the hybrid device of FIG. 5A.

FIG. 5E is a perspective view of a deposition end of the hybrid device of FIG. 5A.

FIG. 6A is a top perspective view of an example hybrid device having a subtractive tool received in a central channel of the hybrid device according to another embodiment of the present disclosure.

FIG. 6B is a bottom perspective view of the hybrid device of FIG. 6A.

FIG. 6C is a cross-sectional side view of the hybrid device of FIG. 6A.

FIG. 7A is a side view of an example hybrid device having a subtractive tool received in an insert sleeve received in a central channel of the hybrid device according to another embodiment of the present disclosure.

FIG. 7B is a cross-sectional side view of the hybrid device of FIG. 7A.

FIG. 7C is a cross-sectional side view of the hybrid device of FIG. 7A with the subtractive tool removed for illustrative purposes.

FIG. 7D is a perspective view of an insert sleeve removed from the hybrid device of FIG. 7A for illustrative purposes.

FIG. 7E is an exploded view of the hybrid device of FIG. 7A.

FIG. 7F illustrates a method of receiving the insert sleeve of FIG. 7D in a shoulder of the hybrid device of FIG. 7A.

FIG. 7G is a perspective view of the hybrid device of FIG. 7A with the insert sleeve received in the shoulder visible.

FIG. 8A is a perspective view of an example hybrid device having an example subtractive tool received in a central channel of the hybrid device according to another embodiment of the present disclosure.

FIG. 8B is perspective view of an example hybrid device having another example subtractive tool received in a central channel of the hybrid device according to another embodiment of the present disclosure.

FIGS. 8C and 8D are perspective views of an insert sleeve removed from the hybrid device of FIG. 8A for illustrative purposes.

FIG. 9 is a schematic illustration of the hybrid device of FIG. 6A being used to remove material through an example subtractive manufacturing process according to an embodiment of the present disclosure.

FIGS. 10A-10B are schematic illustrations of the hybrid device of FIG. 6A being used to remove material through an example subtractive manufacturing process according to an embodiment of the present disclosure.

FIGS. 11A-11B are schematic illustrations of the material removed through the subtractive manufacturing process shown in FIGS. 10A-10B.

FIGS. 12A-12B are schematic illustrations of a hybrid device of FIG. 6A being used to remove material through an example subtractive manufacturing process according to another embodiment of the present disclosure.

FIG. 13 is a flow chart representing an example method of using a hybrid device according to an embodiment of the present disclosure.

### DETAILED DESCRIPTION

The present disclosure relates to hybrid additive and subtractive friction stir additive manufacturing (FSAM) devices and systems. The devices and systems are capable of both additive friction stir deposition (AFSD), a type of FSAM, and subtractive manufacturing (for example, machining). Embodiments of hybrid devices according to the present disclosure can include additive manufacturing devices that include additive manufacturing components (such as shoulders configured to plasticize and deposit a filler material in an additive manufacturing process) and subtractive tools. The subtractive tools according to embodiments of the present disclosure can be configured to remove solidified filler material that was deposited by the additive manufacturing components during the additive manufacturing process. Accordingly, it will be understood that hybrid devices referenced throughout this disclosure can include additive manufacturing devices that include subtractive tools.

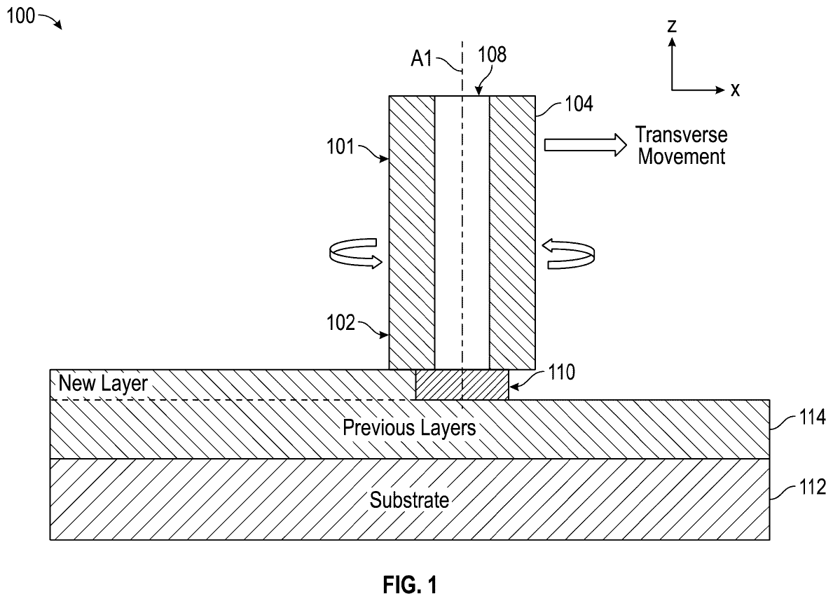

FIG. 1 depicts an example FSAM process and an example FSAM device 100 according to an embodiment of the present disclosure. The FSAM device 100 can include a rotating shoulder 104. The rotating shoulder 104 can include a central channel 108. The central channel 108 can extend from a first end 101 of the rotating shoulder 104 to a second end 102 of the rotating shoulder 104. The second end 102 may also be referred to as a deposition end. The FSAM device 100 can be used to deposit a filler matter to a deposition zone 110. The deposition zone 110 can include the area where the filler material exits the FSAM device 100 and/or the area where the filler material contacts a substrate 112 or previous layers of deposited material 114. The deposition zone 110 can move as the FSAM device 100 is moved across the substrate 112. In other terms, the deposition zone 110 can be the area between the FSAM device 100 and the substrate 112 and include the area where the filler material is deposited.

During the process softened filler material is provided to the deposition zone. The filler material can flow through the central channel 108 of the rotating shoulder 104. The rotating shoulder 104 can be a tool head of an FSAM device 100. The shoulder 104 containing the filler material can rotate about a central axis A1 extending through the center of the shoulder 104. The direction of rotation of the shoulder 104 about the central axis A1 can be clockwise or counter clockwise. In addition to rotating about an axis, the shoulder is capable of transverse movement. The rotation of the shoulder 104 can generate heat to soften the filler material, allowing the filler material to flow out through an opening to the deposition zone. For example, the filler material can flow through the central channel 108 and to the deposition zone 110. The filler material can flow from the first end 101 of the shoulder 104 to the second end 102 of the shoulder 104. The central channel 108 can be configured to allow the filler material to pass through the shoulder 104 from the first end 101 to the second end 102. The shoulder 104 can be moved repeatedly to build up additional layers.

The shoulder 104 can be configured to move across or above the surface of the substrate 112. In one example, the shoulder 104 moves in a transverse direction relative to the substrate 112. For example, with reference to FIG. 1, the direction of movement of the shoulder 104 relative to the page can be left to right. Alternatively, the substrate 112 can be moved and the shoulder 104 can remain stationary. While being moved across or advanced along the surface of the substrate 112, the filler material can continue to be deposited to the deposition zone 110.

The present disclosure discloses hybrid FSAM and/or AFSD devices that can include subtractive manufacturing features without interfering with the standard additive manufacturing tool operations. The hybrid devices according to embodiments of the present disclosure, may include any of the features of the FSAM device described with reference to FIG. 1, and should not be limited to the particular embodiments described.

The hybrid additive and subtractive manufacturing devices described herein can enable additive and subtractive operations on a standard AFSD and/or FSAM machine. In some examples of the present disclosure, both an additive manufacturing process and a substrative manufacturing process can be provided by one device without moving the work-piece, changing tools, and or re-calibrating the tool. This can reduce manufacturing flow time, enable new design configurations, and/or provide flexibility for repairs or dynamic dimensional changes. Additionally, the devices enable the correction of manufacturing mistakes or errors with both additive and subtractive capabilities. This can significantly shorten manufacturing flow time by combining manufacturing steps. The devices can also be used to create integrated channels and enclosures, and can be optionally combined with a “pick-and-place” robot to embed additional components within an additively manufactured structure (for example, electronics and fluid systems). Advantageously, embodiments according to the present disclosure can include the use of an automatic tool changer within an AFSD or FSAM enclosure to swap, exchange, and/or replace elements of the tools (for example, different cutting or drilling feature sizes and orientations).

In some examples, the hybrid device can be a bar-fed device that has been modified to include substrative features. An additive manufacturing tool can be integrated with cutting and drilling features for subtractive manufacturing processes. In some embodiments of the hybrid device according to embodiments of the present disclosure, a dual-use tool is capable of being used as both additive and subtractive machines in a single enclosure, without removing the part or work-piece from the enclosure. The rotary nature of the tool can permit the dual uses. In some embodiments, the subtractive manufacturing features can be located on the side and/or face of the AFSD tool, enabling planing, end-milling, drilling, and/or down-cutting operations.

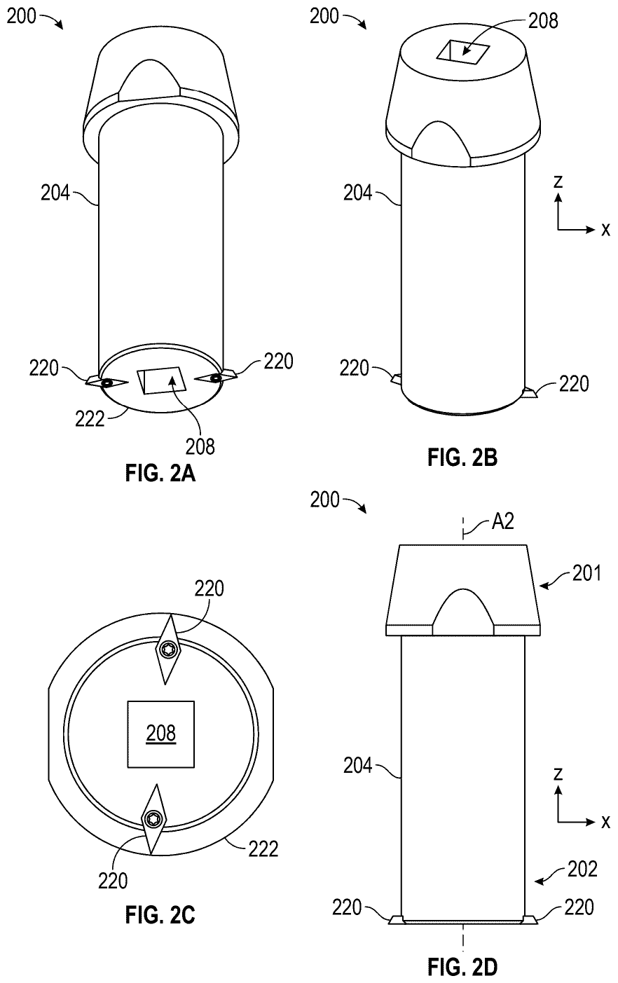

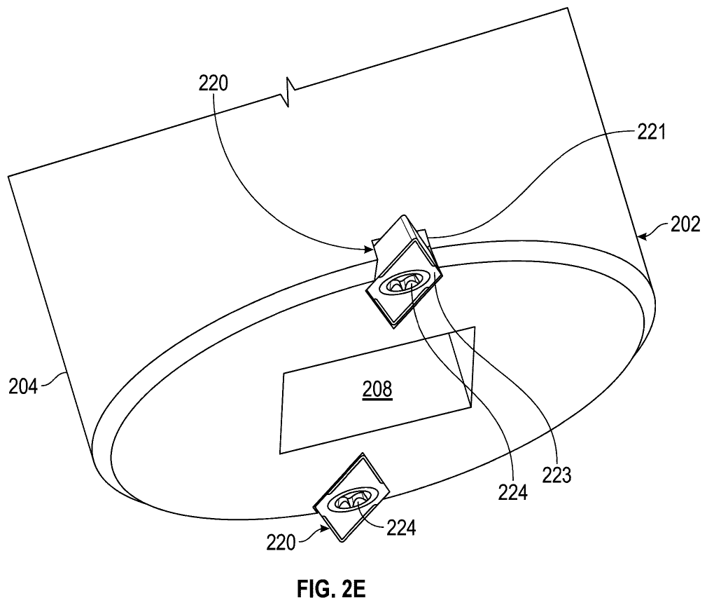

FIGS. 2A-2E illustrate an example hybrid device 200 according to an embodiment of the present disclosure. Embodiments of the example hybrid device 200 shown in FIGS. 2A-2E may include any of the features of the devices discussed above or below, and should not be limited to the particular embodiments described. For example, features of one embodiment may be combined with features of another embodiment. The particular features shown in FIGS. 2A-2E will now be discussed in detail, and features not discussed will be understood to be similar, or identical, to those discussed elsewhere herein. Some or all of the features discussed with respect to FIGS. 2A-2E may be incorporated into the other embodiments described herein.

The hybrid device 200 can include a shoulder 204. The shoulder 204 can be configured to rotate about a central axis A2. The shoulder 204 can include a central channel 208. The central channel 208 can extend from a first end 201 of the shoulder 204 to a second end 202 of the shoulder 204. The second end 202 may also be referred to as a deposition end. The central channel 208 may have a circular, square, or rectangular cross section. Other cross-sectional shapes can be suitably implemented. The rotation of the shoulder 204 can generate heat to soften the filler material, allowing the filler material to flow out through an opening to a deposition zone. For example, the filler material can flow through the central channel 208 and to the deposition zone. The filler material can flow from the first end 201 of the shoulder 204 to the second end 202 of the shoulder 204. The central channel 208 can be configured to allow the filler material to pass through the shoulder 204 from the first end 101 to the second end 102. The shoulder 204 can be moved repeatedly to build up additional layers.

The hybrid device 200 can include one or more subtractive features. In example embodiments, subtractive features can be one or more subtractive tools 220. For example, the hybrid device 200 can include one, two, three, four or more subtractive tools 220. The subtractive tool 220 includes one or more cutting surfaces or edges. The subtractive tools 220 can be configured to machine or remove material deposited through an additive manufacturing process, for example an additive manufacturing process performed by the hybrid device 200 that includes the subtractive tools 220. In some embodiments, the subtractive tools 220 can be inserted parallel to a tool face 222 of the hybrid device 200. The subtractive tools 220 inserted parallel to the tool face 222 can remove material in the x-direction and/or in the y-direction relative to the rotating shoulder 204. The subtractive tools 220 can be positioned such that they extend in a radial direction from an outer surface of the rotating shoulder 204. The subtractive tools 220 may be positioned such that a surface 223 of the subtractive tool 220 is flush with a surface of the tool face 222. Inserting the subtractive tools 220 parallel to and aligned with or above the bottom of the tool face 222 can reduce or prevent any interference with material being deposited by the hybrid device 200. In embodiments of the present disclosure, the subtractive tools 220 will not interact with deposited material until the tool is intentionally positioned such that the subtractive tools 220 will contact the material deposited.

The subtractive tool 220 can be positioned at least partially within a recessed area 221 of the shoulder 204. The subtractive tools 220 can be coupled to the shoulder 204 via a fastener 224, for example, a screw. The subtractive tool 220 can be replaced with a new subtractive tool 220 in the event of wear or dulling of the cutting edges. A portion of the subtractive tool 220 extending out of the recessed area 221 of the shoulder 204 may have a pointed shape and/or sharp edge. In some embodiments, the subtractive tool 220 may have a diamond shape. For example, the subtractive tool 220 may have a diamond cross-sectional shape. The portion of the subtractive tool 220 extending out of the recessed area 221 of the shoulder 204 may have a triangular cross-sectional shape. Other shapes can be suitably implemented. The subtractive tool 220 can include a milling insert. The portion of the subtractive tool 220 extending out of the recessed area 221 can include the one or more cutting surfaces or edges. The portion of the subtractive tool 220 extending out of the recessed area 221 may be configured to machine, shape, or cut material. In embodiments having more than one subtractive tool 220, the subtractive tools 220 may be circumferentially spaced about an outer perimeter of the second end 202 of the shoulder 204. As described above, in some examples, the circumferentially spaced subtractive tools 220 may be positioned such that a surface 223 of the subtractive tool 220 is flush with a surface of the tool face 222. In the non-limiting embodiment of FIGS. 2A-2E, the hybrid device 200 includes two diametrically opposite subtractive tools 220. Non-limiting examples of material for the subtractive tool 220 include carbide, cobalt, or tooling steel. Other numbers and relative positions of subtractive tools 220 can be suitably implemented in accordance with embodiments of the present disclosure.

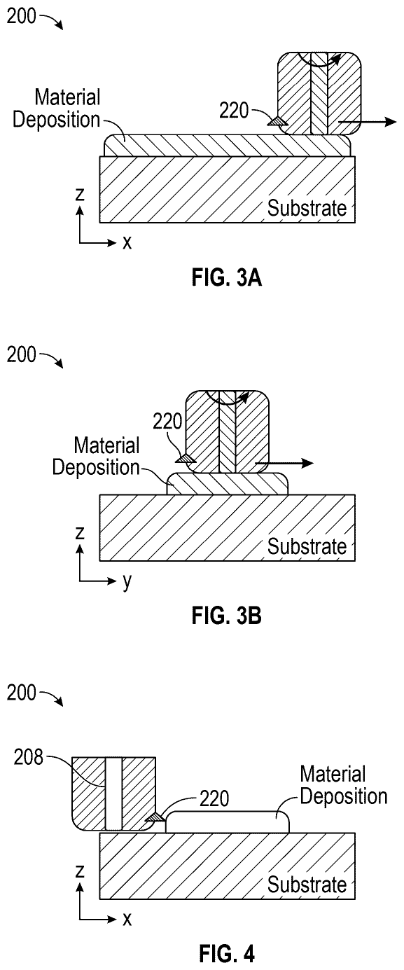

FIGS. 3A and 3B schematically illustrate the hybrid device 200 being used to deposit material in an additive manufacturing process, or additive phase. In the embodiment of FIG. 3A, the hybrid device 200 deposits material as it translates in the x-direction. In the embodiment of FIG. 3B, the hybrid device 200 deposits material as it translates in the y-direction. As shown, the subtractive element 220 does not contact material that has been deposited nor interfere with the deposition of material by the hybrid device 200 as the hybrid device 200 translates in the x-direction and/or the y-direction. While FIGS. 3A and 3B schematically illustrate the subtractive tool 220 as positioned a distance away from the tool face of the hybrid device 200, the subtractive tool 220 may also be positioned flush with the tool face as shown in FIGS. 2A-2E. Advantageously, in such examples where the lowermost surface of the subtractive tool 220 is flush with, or in the same plane as, the tool face of the hybrid device 200, the subtractive tool 220 may contact material that has been deposited but it does not impact or interfere with the material that has been deposited.

FIG. 4 schematically illustrates the hybrid device 200 being used to remove material in in a substrative manufacturing process. The hybrid device 200 may remove material in the y-direction and/or the x-direction relative to the rotating shoulder 204. In some non-limiting embodiments, the hybrid device 200 may remove material in the z-direction relative to the rotating shoulder 204. As shown the central channel 208 is substantially free of filler material and is not depositing material during the subtractive manufacturing process. The hybrid device 200 has been positioned such that the subtractive tool 220 will contact and remove a portion of the material that was deposited in the additive phase. For example, the material may have been deposited by the hybrid device 200 during an additive manufacturing process illustrated in FIG. 3A and/or FIG. 3B. Advantageously, hybrid devices 200 according to the present disclosure can perform an additive manufacturing process followed by a subtractive manufacturing process (once or repeatedly in an iterative process) without removing the substrate from a processing enclosure.

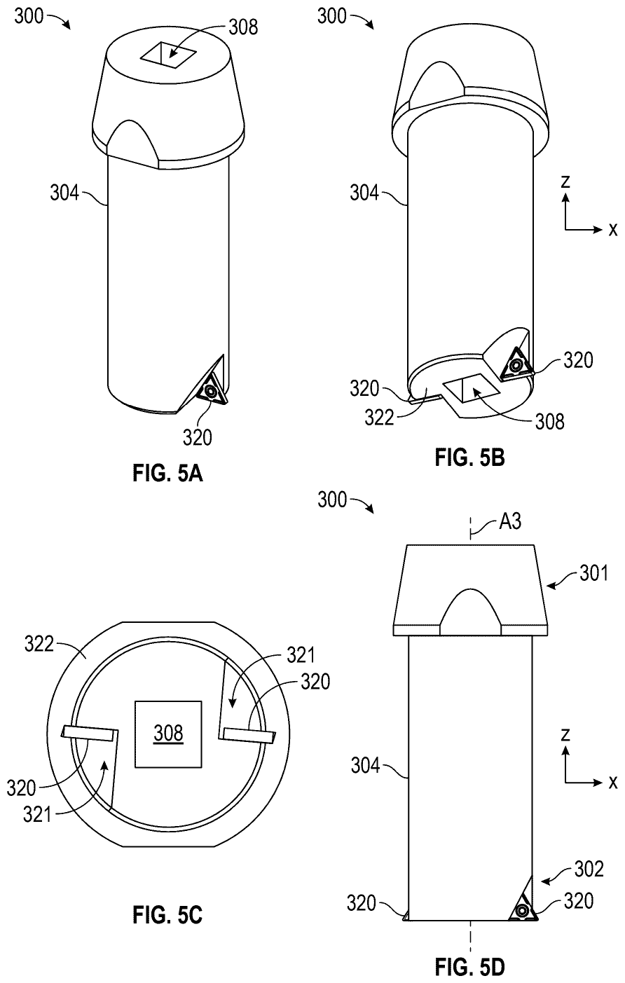

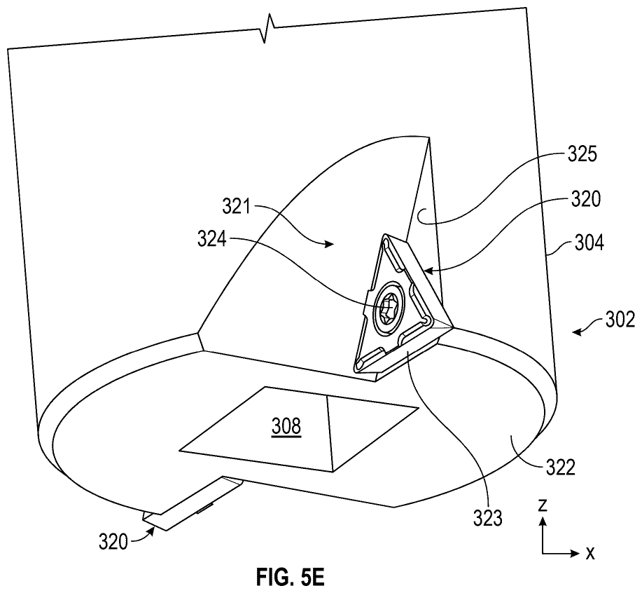

FIGS. 5A-5E illustrate an example hybrid device 300 according to another embodiment of the present disclosure. Embodiments of the example hybrid device 300 shown in FIGS. 5A-5E may include any of the features of the devices discussed above or below, and should not be limited to the particular embodiments described. For example, features of one embodiment may be combined with features of another embodiment. The particular features shown in FIGS. 5A-5E will now be discussed in detail, and features not discussed will be understood to be similar, or identical, to those discussed elsewhere herein. Some or all of the features discussed with respect to FIGS. 5A-5E may be incorporated into the other embodiments described herein.

The hybrid device 300 can include a shoulder 304. The shoulder 304 can be configured to rotate about a central axis A3. The shoulder 304 can include a central channel 308. The central channel 308 can extend from a first end 301 of the shoulder 304 to a second end 302 of the shoulder 304. The second end 302 may also be referred to as a deposition end. The central channel 308 may have a circular, square, or rectangular cross section. Other cross-sectional shapes can be suitably implemented. The rotation of the shoulder 304 can generate heat to soften the filler material, allowing the filler material to flow out through an opening to a deposition zone. For example, the filler material can flow through the central channel 308 and to the deposition zone. The filler material can flow from the first end 301 of the shoulder 304 to the second end 302 of the shoulder 304. The central channel 308 can be configured to allow the filler material to pass through the shoulder 304 from the first end 301 to the second end 302. The shoulder 304 can be moved repeatedly to build up additional layers.

The hybrid device 300 can include one or more subtractive features. In example embodiments, the subtractive features can be one or more subtractive tools 320. For example, the hybrid device 300 can include one, two, three, four or more subtractive tools 320. The subtractive tool 320 includes one or more cutting surfaces or edges. The subtractive tools 320 can be configured to machine or remove material deposited through an additive manufacturing process. In some embodiments, the subtractive tools 320 can be inserted generally perpendicular to the tool face 322 of the hybrid device 300. The subtractive tools 320 shown in FIGS. 5A-5E can remove material in the z-direction relative to the rotating shoulder 304. In some non-limiting embodiments, the hybrid device may remove material in the x-direction and/or the y-direction relative to the rotating shoulder 304.

The subtractive tools 320 can extend a distance in the z-direction, beyond the bottom surface of the tool face 322, allowing the subtractive tools 320 to interact with the deposited material. In some instances, the subtractive tools 320 can be attached to the hybrid device 300 after material has been deposited, to avoid interference with the material as it is deposited using the hybrid device 300. The subtractive tools 320 may be inserted at an angle to allow for an improved interaction with the surface of the deposited material.

In some embodiments, the subtractive tool 320 may be positioned such that a surface 323 of the subtractive tool 320 is flush with a surface of the tool face 322. The subtractive tool 320 may have a portion that extends in a radial direction from an outer surface of the rotating shoulder 304, as is visible in FIG. 5D. The portion of the subtractive tool 320 that extends in the radial direction from the outer surface of the rotating shoulder 304 may remove material in the x-direction and/or in the y-direction relative to the rotating shoulder 304.

The subtractive tool 320 can be positioned at least partially within a recessed area 321 of the shoulder 304. The recessed area 321 may extend from the second end 302 of the shoulder 304 in a direction toward the first end 301 of the shoulder 304. The recessed area 321 may include a wall 325 to which the subtractive tool 320 is coupled. The wall 325 may be perpendicular to or generally perpendicular to the tool face 322. The subtractive tool 320 can be coupled to the shoulder 304 via a fastener 324, for example, a screw. The subtractive tool 320 can be replaced with a new subtractive tool 320 in the event of wear or dulling of the cutting edges. A portion of the subtractive tool 320 extending out of the recessed area 321 of the shoulder 304 may have a pointed shape and/or sharp edge. In some embodiments, the subtractive tool 320 may have a triangular shape. For example, the subtractive tool 320 may have a triangular cross-sectional shape. Other shapes can be suitably implemented. A corner of the triangular shape may be the portion extending out of the recessed area 321. The subtractive tool 220 can include a milling insert. The portion of the subtractive tool 320 extending out of the recessed area 321 can include the one or more cutting surfaces or edges. The portion of the subtractive tool 320 extending out of the recessed area 321 may be configured to machine, shape, or cut material. In embodiments having more than one subtractive tool 320, the subtractive tools 320 may be circumferentially spaced about an outer perimeter of the second end 302 of the shoulder 304. As described above, in some examples, the circumferentially spaced subtractive tools 320 may be positioned such that a surface 323 of the subtractive tool 320 is flush with a surface of the tool face 322. In the non-limiting embodiment of FIGS. 5A-5E, the hybrid device 300 includes two diametrically opposite subtractive tools 320. Non-limiting examples of material for the subtractive tool 220 include carbide, cobalt, or tooling steel. Other numbers and relative positions of subtractive tools 320 can be suitably implemented in accordance with embodiments of the present disclosure.

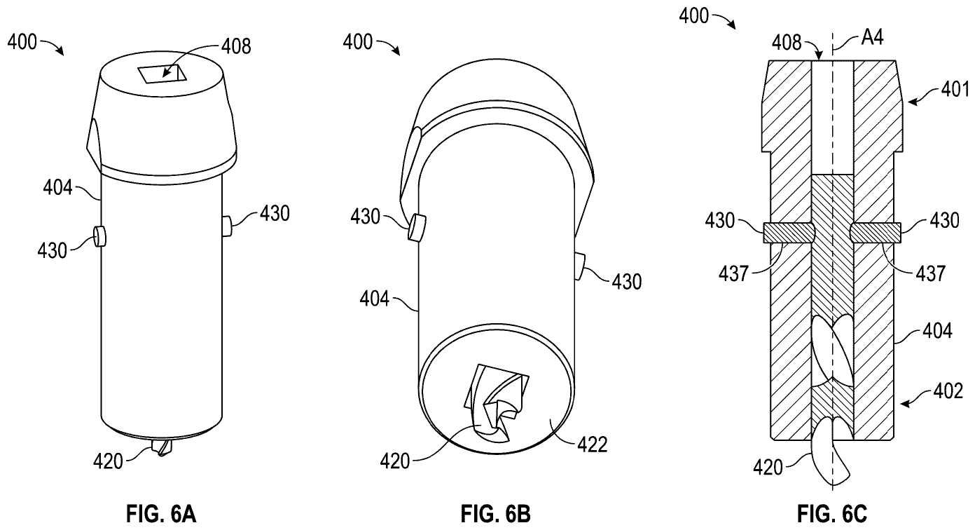

FIGS. 6A-8D illustrate example hybrid devices 400 according to other embodiments of the present disclosure. Embodiments of the example hybrid devices 400 shown in FIGS. 6A-8D may include any of the features of the devices discussed above or below, and should not be limited to the particular embodiments described. For example, features of one embodiment may be combined with features of another embodiment. The particular features shown in FIGS. 6A-8D will now be discussed in detail, and features not discussed will be understood to be similar, or identical, to those discussed elsewhere herein. Some or all of the features discussed with respect to FIGS. 6A-8D may be incorporated into the other embodiments described herein.

The hybrid device 400 can include a shoulder 404. The shoulder 404 can be configured to rotate about a central axis A4. The shoulder 404 can include a central channel 408. The central channel 408 can extend from a first end 401 of the shoulder 404 to a second end 402 of the shoulder 404. The second end 402 may also be referred to as a deposition end. The central channel 408 may have a circular, square, or rectangular cross section. Other cross-sectional shapes can be suitably implemented. The rotation of the shoulder 404 can generate heat to soften the filler material, allowing the filler material to flow out through an opening to a deposition zone. For example, the filler material can flow through the central channel 408 and to the deposition zone. The filler material can flow from the first end 401 of the shoulder 404 to the second end 402 of the shoulder 404. The central channel 408 can be configured to allow the filler material to pass through the shoulder 404 from the first end 401 to the second end 402. The shoulder 404 can be moved repeatedly to build up additional layers.

In some embodiments, a subtractive tool 420 may be removably received in the central channel 408 for use during subtractive manufacturing processes. The subtractive tool 420 may be a drilling, cutting, or milling tool. The subtractive tool 420 includes one or more cutting surfaces or edges. For example, the subtractive tool 420 can include a first end and the one or more cutting surfaces or edges at a second end opposite the first end. At least a portion of the one or more cutting surface or edges may extend outside the central channel 408 of the shoulder 404 when a first end of the subtractive tool 420 is received in the central channel 408 of the shoulder 404. In one non-limiting example, the subtractive tool 420 includes a drill bit. In some embodiments, the subtractive tool 420 includes an HSS (high speed steel) drill bit. In some embodiments, the subtractive tool 420 includes an end mill. In another non-limiting example, the subtractive tool 420 includes a milling insert. A drilling, cutting, and/or milling tool may be inserted and removably received in the central channel 408 of the rotating shoulder 404, as shown in FIGS. 6A-8B. After a drilling, cutting, and/or milling process using the tool, the tool can be removed from the central channel 408, in order to insert a second, different tool to the central channel 408 and/or in order to perform subsequent additive manufacturing processes on the work-piece. The subtractive tool 420 may be positioned such that a portion of the subtractive tool 420 extends out of the central channel 408, for example beyond a tool face 422. Rotation of the shoulder 404 can rotate the subtractive tool 420 received in the central channel 408, causing the subtractive tool to drill or cut material, for example material that was deposited through the central channel 408 of the hybrid device 400 during an earlier additive manufacturing process. In some examples, the AFSD tool includes drilling and additional cutting tools inserted and secured in the central channel 408 of the rotating shoulder using an internal groove feature and a securing mechanism.

As shown in FIGS. 6A-6C, in some embodiments, the subtractive tool 420 can be removably received directly in the central channel 408 of the rotating shoulder 404. The subtractive tool 420 may be secured in the central channel 408 using one or more fasteners, pins, rods or securing mechanisms 430 extending through a sidewall of the rotating shoulder 404. The securing mechanism 430 can be a set screw. In embodiments having more than one securing mechanism 430, the securing mechanisms 430 can be circumferentially spaced about the shoulder 404. The securing mechanism 430 can be inserted through a fastener channel 437 (such as a screw channel 437) in the sidewall of the shoulder 404. The fastener channel 437 may have a first opening in an outer surface of the sidewall of the shoulder 404 and a second opening in a wall of the central channel 408. The securing mechanism 430 may apply a force to an outer surface of the subtractive tool 420 to fix the subtractive tool 420 within the central channel 408. In some embodiments, the securing mechanism 430 may engage a recess in an outer surface of the subtractive tool 420. The subtractive tool 420 may operate between about 200 rpm and about 4,000 rpm depending on the material being removed or machined and/or the size (for example, diameter) of the subtractive tool 420. Smaller subtractive tools 420 (for example, drill bits) may be operated at faster rotation speeds. An example small subtractive tool 420 includes a ¼ inch drill bit. The rotation speed may be increased for smaller subtractive tools 420, which generate less friction relative to larger subtractive tools 420. Larger subtractive tools 420 (for example, drill bits) may be operated at slower rotation speeds. In one non-limiting example, a ¼ inch drill bit removing aluminum filler material may operate at speeds of about 4,000 rpm. In another non-limiting example, a ½ inch drill bit removing aluminum filler material may operate at speeds of about 250 rpm to about 300 rpm.

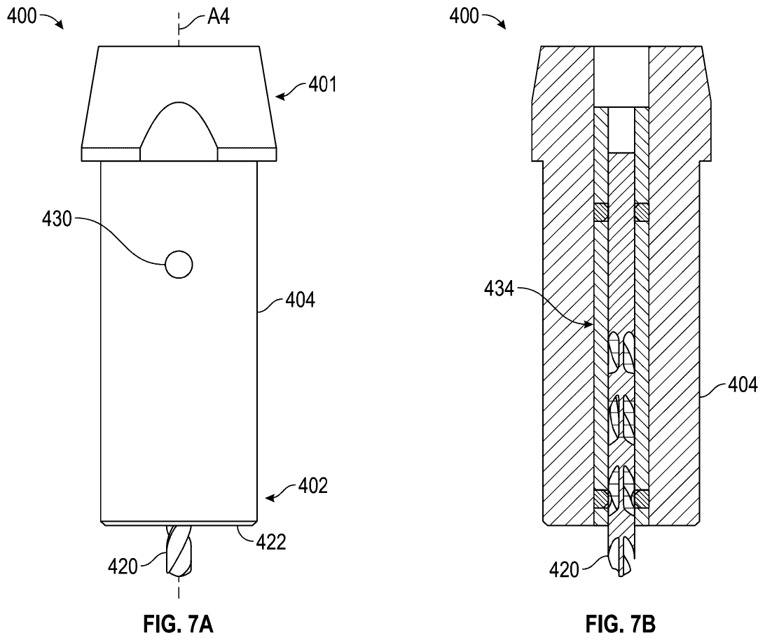

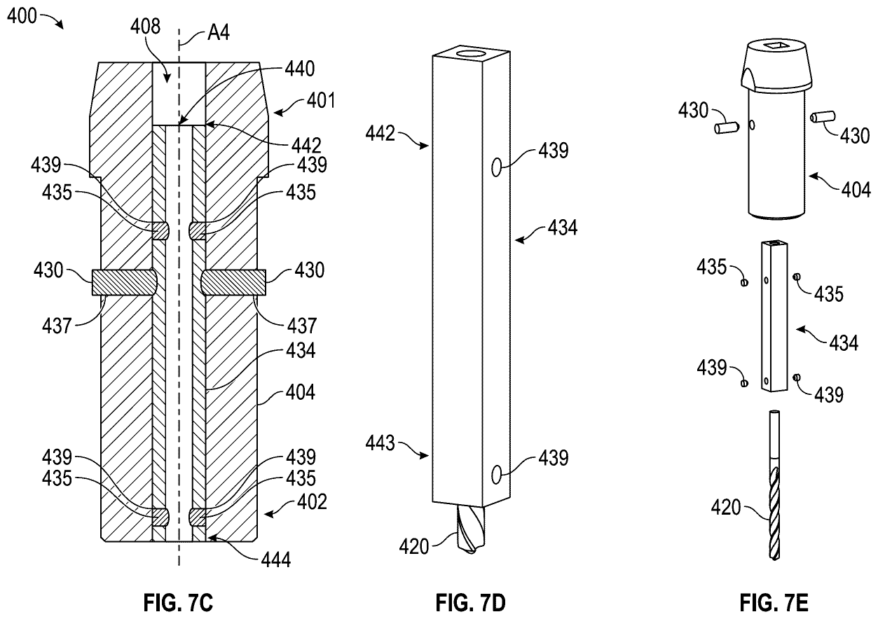

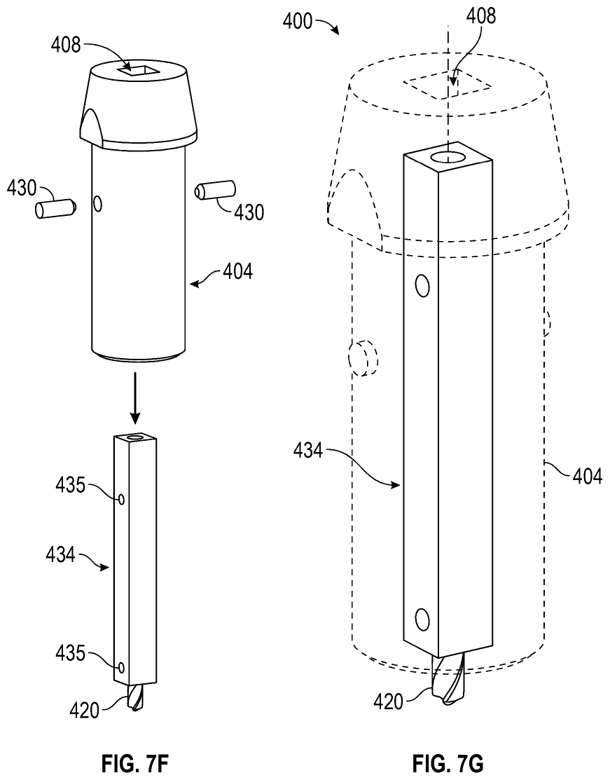

Embodiments of hybrid devices according to the present disclosure can include subtractive tool assemblies. The subtractive tool assembly can include one or more subtractive tools and an insert sleeve. FIGS. 7A-7G are views of an embodiment of an insert according to an embodiment of the present disclosure. Embodiments of the example insert sleeve shown in FIGS. 7A-7G may include any of the features of the devices discussed above or below, and should not be limited to the particular embodiments described. For example, features of one embodiment may be combined with features of another embodiment. The particular features shown in FIGS. 7A-7G will now be discussed in detail, and features not discussed will be understood to be similar, or identical, to those discussed elsewhere herein. Some or all of the features discussed with respect to FIGS. 7A-7G may be incorporated into the other embodiments described herein.

In the non-limiting embodiment of FIGS. 7A-7G, the subtractive tool 420 can be indirectly coupled to or received in the central channel 408 of the hybrid device 400 with an insert sleeve 434. The subtractive tool 420 can first be removably received in the insert sleeve 434. The insert sleeve 434 may have an outer shape that generally corresponds to a shape of the central channel 408. The insert sleeve 434 may have a cross-sectional shape that generally corresponds to a cross-sectional shape of the central channel 408. In one non-limiting example, the central channel 408 may have a generally square cross-sectional shape that corresponds to a generally square cross-sectional shape of the insert sleeve 434. In another non-limiting example, the central channel 408 may have a generally circular cross-sectional shape that corresponds to a generally circular cross-sectional shape of the insert sleeve 434.

The insert sleeve 434 holding the subtractive tool 420 can be removably received in the central channel 408 of the rotating shoulder 404 using one or more fasteners, pins, rods, or securing mechanisms 430. The securing mechanism 430 can be a set screw. The securing mechanism 430 can extend through a sidewall of the rotating shoulder 404. In embodiments having more than one securing mechanism 430, the securing mechanisms 430 can be circumferentially spaced about the shoulder 404. The securing mechanism 430 can be inserted through the fastener channel 437 in the sidewall of the shoulder 404. The securing mechanism 430 may apply a force to an outer surface of the insert sleeve 434 to fix the insert sleeve 434 within the central channel 408. In some embodiments, the securing mechanism 430 may engage a recess in an outer surface of the insert sleeve 434. The use of an insert sleeve 434 can be beneficial in allowing subtractive tools 420 of varying sizes and diameters to be received in and removed from the same hybrid device 400. Modular subtractive tools 420 according to embodiments of the present disclosure can allow a single hybrid device 400 to be used to remove different types of materials and/or remove material from different locations of a work-piece, depending on the requirements of a particular process. In some embodiments, the insert sleeve 434 can be secured in the central channel 408 of the rotating shoulder 404 via a glue. To remove the insert sleeve 434 the glue can be heated to allow removal of the insert sleeve 434. The subtractive tool 420 may operate between about 200 rpm and about 4,000 rpm depending on the material being removed or machined and/or the size (for example, diameter) of the subtractive tool 420. Smaller subtractive tools 420 (for example, drill bits) may be operated at faster rotation speeds. An example small subtractive tool 420 includes a ¼ inch drill bit. The rotation speed may be increased for smaller subtractive tools 420, which generate less friction relative to larger subtractive tools 420. Larger subtractive tools 420 (for example, drill bits) may be operated at slower rotation speeds. In one non-limiting example, a ¼ inch drill bit removing aluminum filler material may operate at speeds of about 4,000 rpm. In another non-limiting example, a ½ inch drill bit removing aluminum filler material may operate at speeds of about 250 rpm to about 300 rpm.

The insert sleeve 434 may include an insert cavity 440, as shown in FIG. 7C. In some embodiments, the insert sleeve 434 can have an insert cavity 440 configured to receive filler material at a first end and deposit filler material at a second end. The insert cavity 440 can extend from a first end 442 of the insert sleeve 434 to a second end 444 of the insert sleeve 434, as labeled in FIG. 7D. The insert cavity 440 may have a circular, square, or rectangular cross section. Other cross-sectional shapes can be suitably implemented. The insert cavity 440 may be configured to removably receive the subtractive tool 420. The subtractive tool 420 may be coupled with the insert sleeve 434 via one or more fasteners, pins, rods, or securing mechanisms 435. In embodiments having more than one securing mechanism 435, pairs of securing mechanisms 435 can be positioned on opposite sides of the insert sleeve 434. The securing mechanisms 435 can be inserted through a fastener channel 439 in a wall of the insert sleeve 434. The fastener channel 439 may have a first opening in an outer surface of the wall of the insert sleeve 434 and a second opening in a wall of the insert cavity 440. The securing mechanism 435 may apply a force to an outer surface of the subtractive tool 420 to fix the subtractive tool 420 within the insert cavity 440. In some embodiments, the securing mechanism 435 may engage a recess in an outer surface of the subtractive tool 420. In some embodiments, one or more securing mechanisms 435 and one or more fastener channels 439 can be positioned at or near the first end 442 of the insert sleeve 434 and/or one or more securing mechanisms 435 and one or more fastener channels 439 can be positioned at or near the second end 443 of the insert sleeve 434.

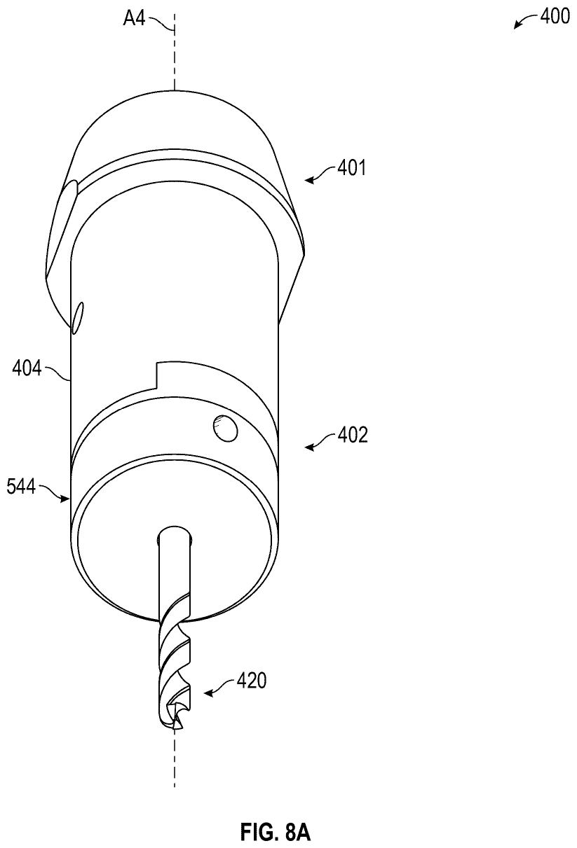

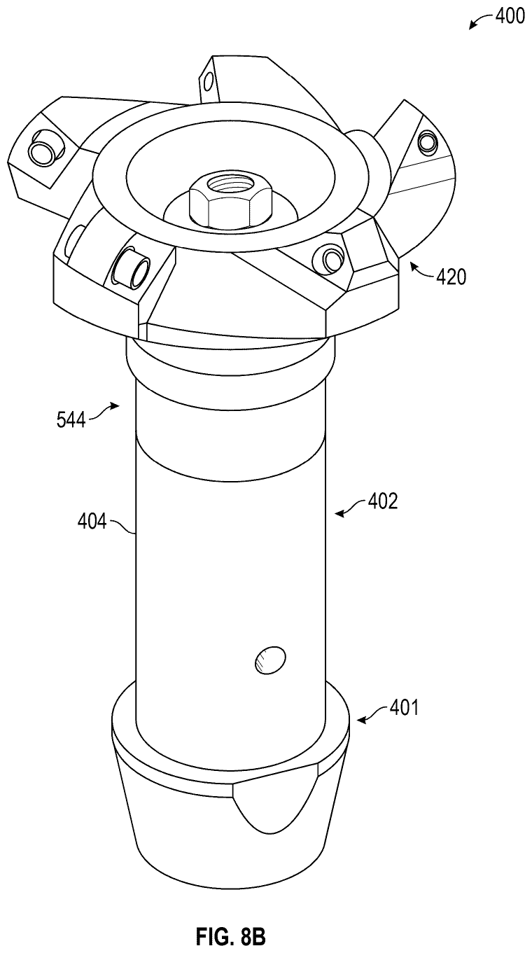

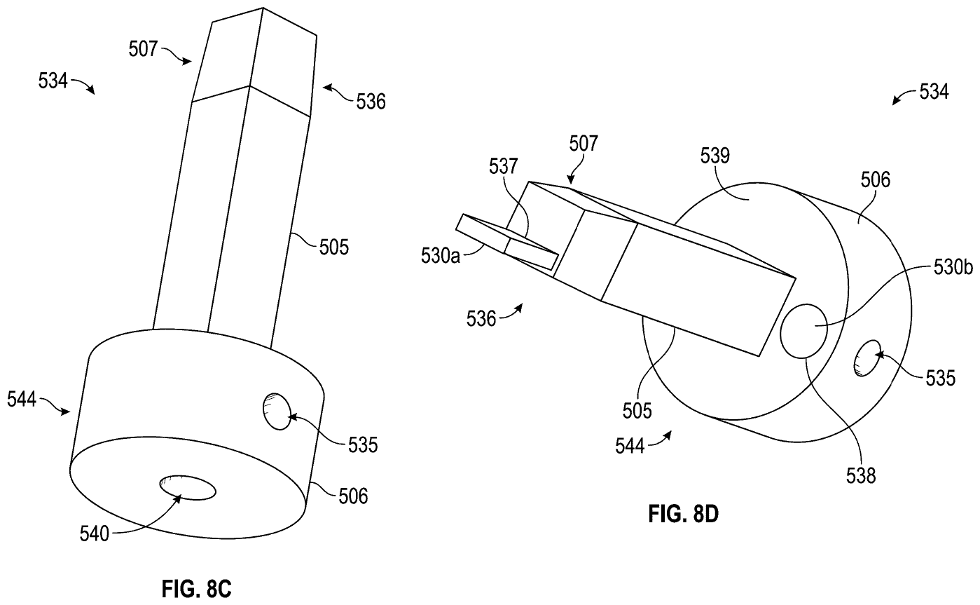

FIGS. 8A-8D are perspective views of another embodiment of an insert sleeve 534 according to an embodiment of the present disclosure. Embodiments of the example insert sleeve 534 shown in FIGS. 8A-8D may include any of the features of the devices discussed above or below, and should not be limited to the particular embodiments described. For example, features of one embodiment may be combined with features of another embodiment. The particular features shown in FIGS. 8A-8D will now be discussed in detail, and features not discussed will be understood to be similar, or identical, to those discussed elsewhere herein. Some or all of the features discussed with respect to FIGS. 8A-8D may be incorporated into the other embodiments described herein.

In the non-limiting embodiment of FIGS. 8A-8D, the subtractive tool 420 can be indirectly received in the central channel 408 of the hybrid device 400 with an insert sleeve 534. The subtractive tool 420 can first be removably received in the insert sleeve 534. The insert sleeve 534 may have an outer shape that generally corresponds to a shape of the central channel 408. The insert sleeve 534 may have a first portion 505 that has a cross-sectional shape that generally corresponds to a cross-sectional shape of the central channel 408. In one non-limiting example, the central channel 408 may have a generally square cross-sectional shape that corresponds to a generally square cross-sectional shape of the first portion 505 of the insert sleeve 534. In another non-limiting example, the central channel 408 may have a generally circular cross-sectional shape that corresponds to a generally circular cross-sectional shape of the first portion 505 of the insert sleeve 534. The first portion 505 may include a tapered section 507. The tapered section 507 can facilitate insertion into and removal from the central channel 408.

The insert sleeve 534 may include a second portion 506. The second portion 506 may have a shape that corresponds to an outer shape of the shoulder 404. For example, the second portion 506 may be a cylindrical portion that has a diameter that generally corresponds to a diameter of the shoulder 404. The second portion 506 may abut the tool face 422 of the shoulder when the first portion 505 is received in the central channel 408. The second portion 506 can improve the stability of the hybrid device 400 and can provide easier access to the subtractive tool 420. The second portion 506 can also allow for subtractive tools 420 with larger diameters, cross sections, or widths to be coupled with the shoulder 404 as shown in FIG. 8B, which illustrates an example shell mill as the subtractive tool 420 coupled with the shoulder 404.

The insert sleeve 534 holding the subtractive tool 420 can be removably received in the central channel 408 of the rotating shoulder 404 using one or more magnets 530. A first magnet 530a may be positioned at a first end 536 of the insert sleeve 534. The first end 536 may be an end of the first portion 505. The first magnet 530a may be positioned at least partially in a cavity or recess 537 at the first end 536 of the insert sleeve 534. The one first magnet 530a may be configured to magnetically couple with a corresponding magnet positioned in the central channel 408 of the shoulder 404 or directly with the shoulder 404 itself (for example, if the shoulder 404 comprises a ferrous material). The subtractive tool 420 may operate under compression, for example, the subtractive tool 420 may apply a compressive force against a surface of the insert sleeve 543. The central channel 408 of the rotating shoulder 404 may capture the geometry of the first magnet 530a (for example, the rectangular-shaped geometry of the first magnet 530a) to prevent rotation of the insert sleeve 534. In some embodiments, one or more fasteners, pins, rods or securing mechanisms 430 extending through a sidewall of the rotating shoulder 404 may be used to secure the insert sleeve 534 to the shoulder 404.

A second magnet 530b may be positioned at least partially in a cavity or recess 538. The cavity 538 may be in a surface 539 of the second portion 506 that abuts the tool face 422 of the shoulder 404. The second magnet 530b may be configured to magnetically couple with a corresponding magnet positioned in the tool face 422 of the shoulder 404 or directly with the tool face 422 itself. For example, if the shoulder 404 comprises a ferrous material.

The insert sleeve 434 may include an insert cavity 540, as shown in FIG. 8C. The insert cavity 540 can be at a second end 544 of the insert sleeve 534. The second end 544 may be an end of the second portion 506. The insert cavity 540 may have a circular, square, or rectangular cross section. Other cross-sectional shapes can be suitably implemented. The insert cavity 540 may be configured to removably receive at least a portion the subtractive tool 420. In some embodiments, the insert cavity 540 can be threaded to engage threads on a portion of the subtractive tool 420. The subtractive tool 420 may be coupled with the insert sleeve 534 via one or more fasteners, pins, rods, or securing mechanisms. The securing mechanisms can be inserted through a fastener channel 535 in a wall of the second portion 506 of the insert sleeve 534. In some embodiments, the fastener channel 535 can be a threaded set screw orifice to secure the subtractive tool 420 in place. The fastener channel 535 may have a first opening in an outer surface of the wall of the second portion 506 of the insert sleeve 534 and a second opening in a wall of the insert cavity 540. The securing mechanism may apply a force to an outer surface of the subtractive tool 420 to fix the subtractive tool 420 within the insert cavity 540. In some embodiments, the securing mechanism may engage a recess in an outer surface of the subtractive tool 420.

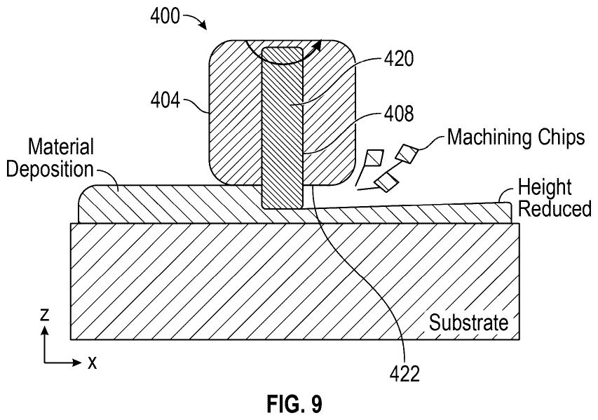

FIGS. 9-11B schematically illustrate the hybrid device 400 being used to machine material that was previously deposited. The hybrid device 400 that machines the material may have deposited the material in a previous additive manufacturing process, or another hybrid device 400B may have deposited the material. As shown in FIG. 9, the hybrid device 400 includes a swappable or removable subtractive tool 420 positioned within the central channel 408 of the rotating shoulder 404 of the hybrid device 400. As shown, the swappable or removable subtractive tool 420 can extend out of the central channel 408 of the rotating shoulder 404, for example beyond a tool face 422 of the rotating shoulder 404. The subtractive tool 420 can include a milling insert. The hybrid device 400 can be positioned such that the subtractive tool 420 contacts and removes a portion of the previously deposited material as the hybrid tool 400 moves in the x-direction. The hybrid device 400 can also be positioned such that the subtractive tool 420 contacts and removes a portion of the previously deposited material as the hybrid tool 400 move in the y-direction. In this example subtractive phase, an end mill or height reduction process can be performed. Other implementations are possible.

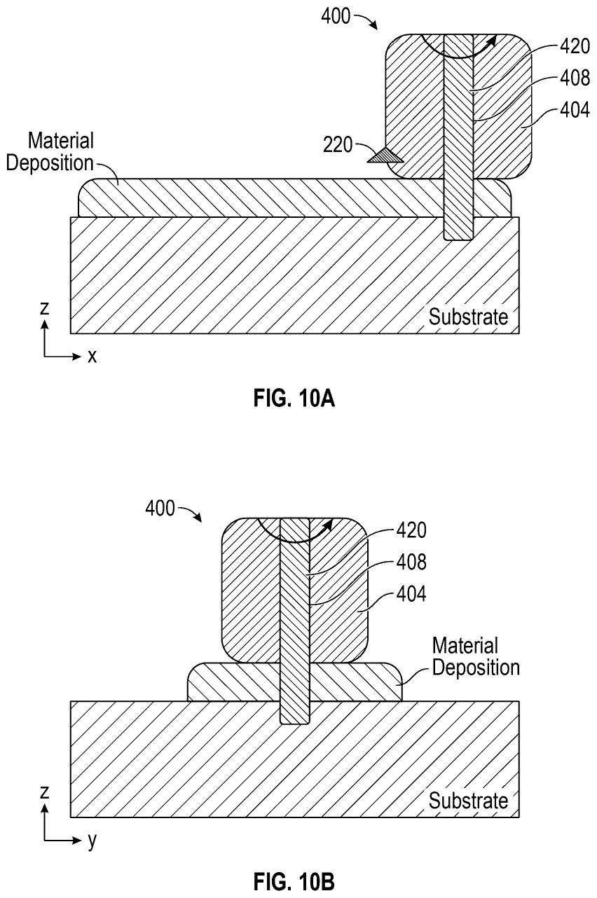

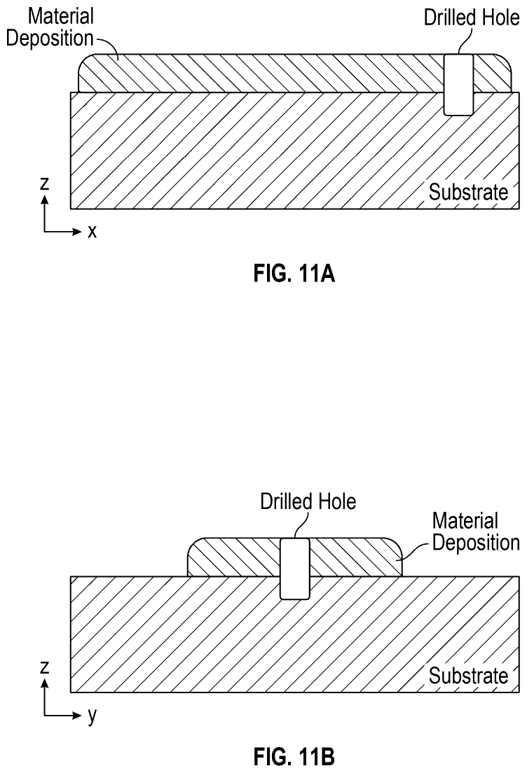

For example, FIGS. 10A and 10B illustrate a swappable or removable subtractive tool 420 positioned within the central channel 408 of the rotating shoulder 404 and drilling through the previously deposited material as the hybrid tool 400 moves in the z-direction. The subtractive tool 420 can be a drill bit or a drilling bit insert. Other types of subtractive tools 420 can be suitably implemented in accordance with the present disclosure. FIG. 10A illustrates the drilling process viewed from the x-z direction. FIG. 10B illustrates the drilling process viewed from the y-z direction. The subtractive tool 420 can be a drill bit or a drilling bit insert. FIG. 11A illustrates the drilled hole viewed from the x-z direction. FIG. 11B illustrates the drilled hole viewed from the y-z direction.

FIGS. 10A and 10B also illustrate that the hybrid device 400 may include one or more second subtractive features, in addition to the subtractive tool 420. For example, the hybrid device 400 can include a subtractive feature 220 as described above with reference to FIGS. 2A-2E. Alternatively, the hybrid device 400 can include a subtractive feature 320 as described above with reference to FIGS. 5A-5E. In FIGS. 10A and 10B, subtractive feature 220 is an inactive subtractive feature. For example, subtractive feature 220 is not performing material removal during the process of removing material using the subtractive tool 420. Subtractive feature 220 may have previously been used to perform subtractive manufacturing processes or may later be used to perform additional subtractive manufacturing processes. Any combination of subtractive features described herein may be implemented in accordance with embodiments of the present disclosure.

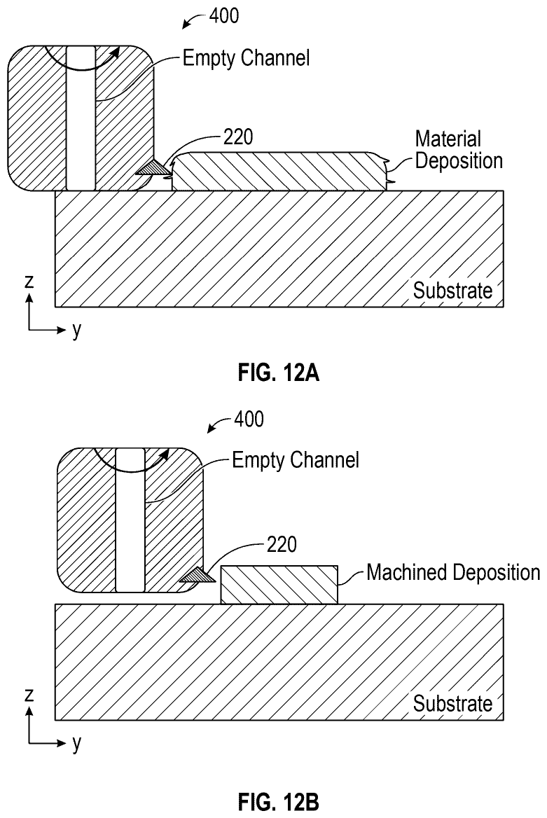

FIGS. 12A and 12B illustrate yet another subtractive phase example, in which the hybrid device is used to perform flash cleanup (for example, a width reduction process). In this example subtractive phase, excess material that was deposited or built-up during a prior additive manufacturing process can be removed by the subtractive tool 220 of the hybrid device 400. The excess material can be flash, such as a raised edge or protrusion, that occurred at the edges of the deposited material during a prior additive manufacturing process. In non-limiting examples of the present disclosure, the prior additive manufacturing process was performed by the hybrid device 400 depositing filler material through the central channel 408 when a subtractive tool 420 was not received in the central channel 408. FIG. 12A illustrates the subtractive phase as the subtractive feature 220 drills, cuts, and/or mills the excess material from the material deposition. FIG. 12B illustrates the now-machined deposition after the subtractive phase is complete and excess material, such as flash, has been removed. The machined deposition can have a reduced width relative to the material as initially deposited by the hybrid device 400. It will be understood that the hybrid device 400 is not limited to subtractive tools 220, and that the hybrid device 400 can include a subtractive feature 320 as described above with reference to FIGS. 5A-5E.

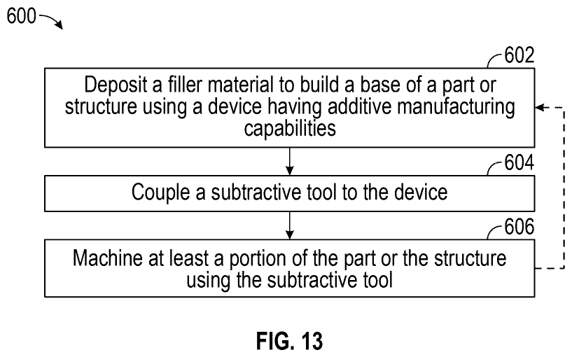

FIG. 13 is a flow chart representing an example method 600 of forming a part or structure using a hybrid device according to an embodiment of the present disclosure (for example, the hybrid device 400). Hybrid device 400 will be used as an example but it will be understood that other hybrid devices, such as the hybrid device 200 described with reference to FIGS. 2A-2E and the hybrid device 300 described with reference to 5A-5E, may implement the method 600. In such examples where the hybrid device includes a subtractive tool that is coupled to the shoulder during an additive manufacturing process and is not received in a central channel of the hybrid device (such as the subtractive tool 220 described with reference to FIGS. 2A-2E and the subtractive tool 320 described with reference to FIGS. 5A-5E), step 604 of the method 600 may be omitted.

Starting at block 602, the hybrid device 400 may be used to deposit a filler material to build a part or structure. Non-limiting examples of parts and structures include propellent tanks, engine components, and other structures launched into or used in space. The filler material may be deposited on a substrate. The hybrid device 400 may be used to deposit the filler material when a subtractive tool 420 is not received directly or indirectly in the central channel 408. As described herein, the rotation of the shoulder 404 can generate heat to soften the filler material, allowing the filler material to flow out through an opening of the shoulder to a deposition zone. For example, the filler material can flow through the central channel 408 and to the deposition zone. The filler material can flow from the first end 401 of the shoulder 404 to the second end 402 of the shoulder 404. The central channel 408 can be configured to allow the filler material to pass through the shoulder 404 from the first end 401 to the second end 402. In some embodiments, the shoulder 404 can be moved repeatedly to build up additional layers. The layers of filler material can transition from a softened state to a hardened state to form a base of the part or structure, or intermediate layers of the part or structure.

Moving to block 604, a subtractive tool 420 can be coupled to the hybrid device 400. In some embodiments, the subtractive tool 420 can be received at least partially in the central channel 408 of the hybrid device 400 according to embodiments of the present disclosure. For example, the subtractive tool 420 can be directly or indirectly coupled to or received at least partially in the central channel 408.

Moving to block 606, at least a portion of the part or structure can be machined using the subtractive tool 420. For example, at least a portion of the part or structure can be drilled, cut, and/or milled using the subtractive tool 420. Holes or recesses can be machine into surfaces of the part or structure. Material can be machined away or removed to change dimensions of the part or structure. In some embodiments, other subtractive tools (for example, subtractive tools 220, 320) may also be used to machine surfaces of the part or structure. In some examples of the method 600, steps 602, 604, and 606 can be repeated to form a final part or structure.

Embodiments of hybrid devices according to the present disclosure can be incorporated into robotic systems and/or gantry-based CNC platforms to free form, join, and repair many different types of structures. The systems described herein can include hybrid devices configured to move in 3 translational and 3 rotational degrees of freedom under control of a control system. Example control systems include a robotic system and a gantry-based CNC platform. Other control systems can be suitably implemented in embodiments of the present disclosure. Embodiments of hybrid devices accordingly to the present disclosure can be mounted to a robotic machine or a gantry-based CNC platform. Advantageously, the incorporation of the hybrid devices onto a robotic system or gantry-based CNC platform can allow the pointing or orientation of the hybrid devices in any direction during use.

Although embodiments of the present disclosure have been described with reference to hybrid devices that include a central channel that extends along a central axis of a shoulder and is configured to receive and deposit a filler material, it will be understood that embodiments of the present disclosure can be suitably implemented in wire-fed additive manufacturing devices. For example, embodiments of the present disclosure can be suitably implemented in devices that include shoulders having off-axis channels configured to receive filler material in the form of wires, in lieu of or in addition to a central channel that extends along a central axis of the shoulder and is configured to receive and deposit a filler material.

While the above detailed description has shown, described, and pointed out features of the present disclosure as applied to various embodiments, it will be understood that various omissions, substitutions, and changes in the form and details of the device or process illustrated may be made by those skilled in the art without departing from the spirit of the present disclosure. As will be recognized, the present disclosure may be embodied within a form that does not provide all of the features and benefits set forth herein, as some features may be used or practiced separately from others. All changes which come within the meaning and range of equivalency of the claims are to be embraced within their scope.

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above description discloses several devices, methods, and materials of the present disclosure. The present disclosure is susceptible to modifications in the devices, methods, and materials, as well as alterations in the fabrication methods and equipment. Such modifications will become apparent to those skilled in the art from a consideration of this disclosure. Consequently, it is not intended that the present disclosure be limited to the specific embodiments disclosed herein, but that it covers all modifications and alternatives coming within the true scope and spirit of the present disclosure.

What is claimed is:

1. An additive manufacturing device comprising:
a shoulder configured to rotate about a central axis, the shoulder comprising a central channel extending from a first end of the shoulder to a second end of the shoulder, the central channel configured to allow a filler material to pass through the shoulder from the first end towards the second end; and
a subtractive tool assembly comprising:
a subtractive tool comprising a first end and one or more cutting surfaces or edges at a second end; and
an insert sleeve comprising an insert cavity configured to removably receive the subtractive tool, the insert sleeve configured to be received in the central channel of the shoulder to couple the subtractive tool to the shoulder, at least a portion of the one or more cutting surfaces or edges of the subtractive tool extending outside the central channel of the shoulder when the first end of the subtractive tool is removably received in the insert cavity of the insert sleeve and the insert sleeve is received in the central channel of the shoulder.

2. The additive manufacturing device of claim 1, wherein the subtractive tool comprises a drill bit or a milling insert.

3. The additive manufacturing device of claim 1, wherein the insert sleeve further comprises a first portion configured to be received in the central channel and a second portion configured to abut a tool face at the second end of the shoulder.

4. The additive manufacturing device of claim 3, wherein the insert sleeve further comprises a first magnet positioned in a cavity of the first portion and a second magnet positioned in a cavity of the second portion, the first magnet and the second magnet configured to couple the insert sleeve to the shoulder.

5. The additive manufacturing device of claim 1, further comprising one or more fasteners configured to couple the subtractive tool to the insert sleeve at a first end of the insert cavity and a second, opposite end of the insert cavity.

6. The additive manufacturing device of claim 1, wherein the insert sleeve is configured to be coupled to the shoulder with a fastener positioned within a fastener channel that extends from an outer surface of a sidewall of the shoulder to a wall defining the central channel of the shoulder.

7. The additive manufacturing device of claim 1, wherein the insert sleeve is configured to be coupled to the shoulder with a glue.

8. The additive manufacturing device of claim 1, wherein the central channel comprises a square cross sectional shape, an outer shape of the insert sleeve comprises a square cross-sectional shape, and the insert cavity comprises a circular cross sectional shape.

9. An additive manufacturing device comprising:
a shoulder configured to rotate about a central axis, the shoulder comprising a central channel extending from a first end of the shoulder to a second end of the shoulder, the central channel configured to allow a filler material to pass through the shoulder from the first end towards the second end; and
a subtractive tool comprising a first end and one or more cutting surfaces or edges at a second end, the subtractive tool configured to be removably received in the central channel of the shoulder, at least a portion of the one or more cutting surfaces or edges of the subtractive tool extending outside the central channel of the shoulder when the first end of the subtractive tool is removably received in the central channel of the shoulder.

10. The additive manufacturing device of claim 9, wherein the subtractive tool comprises a drill bit or a milling insert.

11. The additive manufacturing device of claim 9, wherein the subtractive tool is configured to be coupled in the central channel with one or more screws.

12. The additive manufacturing device of claim 9, wherein the subtractive tool is configured to be directly coupled to the central channel of the shoulder.

13. The additive manufacturing device of claim 9, wherein the subtractive tool is configured to be indirectly coupled to the central channel of the shoulder.

14. The additive manufacturing device of claim 9, wherein the central channel comprises a circular cross sectional shape and the first end of the subtractive tool comprises a circular cross sectional shape.

15. The additive manufacturing device of claim 9, further comprising a second subtractive tool comprising a first end and one or more cutting surfaces or edges at a second end, the second subtractive tool configured to be removably received in the central channel of the shoulder, at least a portion of the one or more cutting surfaces or edges of the second subtractive tool extending outside the central channel of the shoulder when the first end of the second subtractive tool is removably received in the central channel of the shoulder.

16. A method of manufacturing a part comprising:
advancing an additive manufacturing device over a substrate, the additive manufacturing device comprising a shoulder having a central channel configured to deposit a filler material, the shoulder configured to rotate as the additive manufacturing device is advanced;
depositing the filler material to build a part;
coupling a subtractive tool at least partially in the central channel of the shoulder; and
machining at least a portion of the part using the subtractive tool.

17. The method of claim 16, further comprising coupling the subtractive tool at least partially received in the central channel of the shoulder using one or more fasteners.

18. The method of claim 16, further comprising coupling the subtractive tool at least partially received in the central channel of the shoulder using one or more magnets.

19. The method of claim 16, further comprising:
removably receiving the subtractive tool at least partially in an insert cavity of an insert sleeve; and
inserting the insert sleeve in the central channel of the shoulder.

20. The method of claim 19, further comprising coupling the insert sleeve to the shoulder using one or more fasteners positioned within a fastener channel that extends from an outer surface of a sidewall of the shoulder to a wall defining the central channel of the shoulder.

21. The method of claim 16, wherein machining comprises drilling one or more holes in the part.

22. The method of claim 16, wherein machining comprises machining an outer surface of the part to reduce a dimension of the part.

23. The method of claim 16, further comprising:
removing the subtractive tool from the central channel of the shoulder;
advancing the additive manufacturing device over the portion of the part machined using the subtractive tool as the additive manufacturing device deposits filler material;
coupling a second subtractive tool different than the subtractive tool at least partially in the central channel of the shoulder; and
machining at least a portion of the part using the second subtractive tool.
